(19) United States
(12) Patent Application Publication
(10) Pub. No.: US 2013/0253956 A1
(43) Pub. Date: Sep. 26, 2013

(54) CHARGEBACK INSURANCE

(71) Applicants: Robert Lyne Towne, Chapel Hill, NC (US); Nancy Hilgers, Danville, CA (US); Barbara Patterson, South San Francisco, CA (US)

(72) Inventors: Robert Lyne Towne, Chapel Hill, NC (US); Nancy Hilgers, Danville, CA (US); Barbara Patterson, South San Francisco, CA (US)

(21) Appl. No.: 13/623,821

(22) Filed: Sep. 20, 2012

Related U.S. Application Data
(60) Provisional application No. 61/538,071, filed on Sep. 22, 2011.

(51) Int. Cl. G06Q 40/08

(52) U.S. Cl. CPC G06Q 40/08
USPC 705/4

(57) ABSTRACT

Embodiments of the invention are directed to a chargeback insurance program offered through a payment processing network. The payment processing network is capable of processing chargeback requests on behalf of an enrolled merchant or enrolled issuer without requiring additional chargeback-related processes to be conducted by the merchant or issue. Chargebacks are processed by the payment processing network based on enrollment settings in the chargeback insurance program.

### CROSS-REFERENCES TO RELATED APPLICATIONS

This application is a non-provisional application of and claims the benefit of priority of U.S. Provisional Application No. 61/538,071, filed on Sep. 22, 2011, which is herein incorporated by references in its entirety for all purposes.

### BACKGROUND

A chargeback is the return of funds to a consumer for a particular prior transaction. A chargeback request is typically initiated by a financial institution for a financial account used in the transaction against an individual, merchant, or other business entity. Specifically, a chargeback request is sent to reverse a prior outbound transfer of monetary funds from a consumer's bank account or portable consumer device. Chargeback requests can be initiated for a variety of reasons. For example, a consumer may detect fraudulent activity, such as a transaction occurring without the consumer's authorization. Other basis for chargebacks may include, but are not limited to, non-receipt of purchased items, dissatisfaction with purchased items, incorrect charge, and duplicate charge.

For the merchant, chargebacks can be costly. For example, if a fraudulent transaction is conducted by someone without the authority of the consumer, the merchant may lose both the amount of monetary funds for the particular transaction being charged back, as well as the merchandise related to the particular transaction. Merchants may also incur their own additional internal handling costs to process a chargeback, such as by an acquirer computer.

In a typical chargeback transaction, an issuer computer sends a chargeback request message to an acquirer computer associated with the merchant, and approves the chargeback, which involves retrieving funds from an account associated with the merchant.

One of the problems that arises from processing chargeback request messages in this manner is that merchants have little predictability of when chargeback request messages will be received. The merchant's systems thus have to be configured to deal with the possibility of frequent chargebacks. Further, the merchant's account may incur a significant amount of instability if chargebacks are initiated frequently against the merchant's account.

Thus, new and enhanced methods of processing chargeback request messages that can provide merchants greater predictability and stability of merchant accounts are necessary.

Embodiments of the invention address the above problems, and other problems, individually and collectively.

### BRIEF SUMMARY

Embodiments of the invention relate to methods and systems for receiving processing chargeback request messages through a payment processing network based upon evaluating the chargeback request message against an enrolled merchant database.

One embodiment of the invention is directed to a method comprising: receiving, at a server computer, a chargeback request message from an issuer computer, parsing, by the server computer, the chargeback request message and determining, by the server computer, whether a merchant associated with the chargeback request message is enrolled in a chargeback insurance program. If the merchant is enrolled in the chargeback insurance program, the method further comprises, generating, by the server computer, a chargeback response message indicating approval of the chargeback request message, and transmitting, by the server computer, the chargeback response message to the issuer computer.

Another embodiment of the invention is directed to a server computer comprising a processor, and a computer readable medium coupled to the processor, the computer readable medium comprising code for implementing a method. The method comprises receiving, at a server computer, a chargeback request message from an issuer computer, parsing, by the server computer, the chargeback request message and determining, by the server computer, whether a merchant associated with the chargeback request message is enrolled in a chargeback insurance program. If the merchant is enrolled in the chargeback insurance program, the method further comprises, generating, by the server computer, a chargeback response message indicating approval of the chargeback request message, and transmitting, by the server computer, the chargeback response message to the issuer computer.

These and other embodiments of the invention are described in further detail below with reference to the Figures and the Detailed Description.

### BRIEF DESCRIPTION OF THE DRAWINGS

FIG. 1 shows a block diagram of a system according to an embodiment of the invention.

FIG. 2A shows a block diagram of components of a payment processing network according to an embodiment of the invention.

FIG. 2B illustrates a table containing information regarding customizable settings for enrolled merchants according to an embodiment of the invention.

FIG. 3 illustrates a flowchart describing the process of initiating and authorizing a transaction through a system according to an embodiment of the invention.

FIG. 4 illustrates a flowchart describing the clearing and settlement process through a system according to an embodiment of the invention.

FIG. 5 illustrates a flowchart describing the process of processing a chargeback request for a merchant enrolled in a chargeback insurance program through a system according to an embodiment of the invention.

FIG. 6 illustrates a flowchart describing the clearing and settlement process for a chargeback through a system according to an embodiment of the invention.

FIG. 7 illustrates a flowchart describing the process of processing a chargeback request for a merchant not enrolled in a chargeback insurance program through a system according to an embodiment of the invention.

FIG. 8 illustrates a flowchart describing the clearing and settlement process for a chargeback through a system according to an embodiment of the invention.

FIG. 9 shows a block diagram of a computer apparatus according to an embodiment of the invention.

### DETAILED DESCRIPTION

Prior to discussing embodiments of the invention, descriptions of some terms may be helpful in understanding embodiments of the invention.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The term “chargeback request message” may refer to a message sent as part of a chargeback transaction. Typically, chargeback request messages are generated by an issuer financial institution seeking the return of monetary funds for a previous transaction conducted using a user's financial account. The chargeback request message may comply with ISO 8583, which is a standard for systems that exchange electronic transactions made by users using payment devices. A chargeback request message according to other embodiments may comply with other suitable standards. In some embodiments of the invention, a chargeback request message may be comprised of user account data (e.g. user name, user account number), chargeback basis data (e.g. reason for the chargeback request, such as fraud related, service related, and processing related), merchant identification data (e.g. merchant ID, merchant name, merchant address, merchant verification value), and a chargeback amount.

The term “enrolled” may refer to the status of a merchant. In some embodiments, in order for a merchant to be covered by a chargeback insurance program offered by a payment processing network, the merchant must specifically enroll in the chargeback insurance program. For example, in order to be enrolled in the chargeback insurance program, the merchant may have to complete an enrollment process, fulfill payment processing network requirements, and/or pay a daily, weekly, monthly, yearly premium, or a flat per transaction fee. In some embodiments, enrollment in the chargeback insurance program may be automatic as an incentive for conducting business with the payment processing network.

The term “chargeback insurance program” may refer to an insurance program offered to parties to a transaction. In some embodiments, in order to provide predictability and security for the merchant's account, a merchant may enroll in the chargeback insurance program offered by a payment processing network so that the financial institution for a financial account used in a transaction is precluded from obtaining any monetary funds from chargebacks sought against the merchant. Instead, the payment processing network would pay any chargebacks sought against the enrolled merchant.

In some embodiments, a merchant can enroll in a chargeback insurance program offered by a payment processing network. The merchant can either enroll by paying a transaction fee or premium to the payment processing network for the service, or the payment processing network may provide the service as a free benefit to the merchant. Following a transaction between the merchant and a user, a user may contact their issuing bank requesting a chargeback. When a chargeback is initiated by an issuer computer, it transmits chargeback request data to a payment processing network in the form of a chargeback request message. In some embodiments, the payment processing network determines whether the chargeback request is fraud-related. If the chargeback request is not fraud-related, the chargeback request is electronically transmitted to merchant's acquirer computer for payment. If the chargeback request is fraud-related, the payment processing network then compares the data from the chargeback request against a database of merchants enrolled in the chargeback insurance program. If the merchant is not enrolled in the chargeback insurance program, the chargeback request is electronically transmitted to merchant's acquirer computer. If the merchant is enrolled in the chargeback insurance program, the payment processing network processes the chargeback on behalf of the merchant.

In some embodiments, the chargeback insurance program may cover all chargeback requests made against a merchant enrolled in the chargeback insurance program, regardless of the basis for the chargeback. In other embodiments, the chargeback insurance program may cover chargeback requests in certain categories based on merchant or issuer enrollment settings.

In other embodiments, the chargeback insurance program may be offered to both merchant and issuers. In some scenarios, liability for a chargeback may be with the issuer, rather than the merchant. For example, as a card not present transaction (e.g. over the Internet or via a virtual account) does not enable the merchant to do any visual authentication (e.g. of the user's identity or the authenticity of a payment method), the merchant may have greater liability as the merchant may have a greater responsibility to ensure authenticated transactions if they are offering card not present transaction as a method of conducting transactions. Conversely, a card presentation transaction may involve a payment device that is issued by the issuer. Thus, the issuer may have greater liability as the merchant may trust the visual inspection of the payment device.

The term “chargeback response message” may refer to a message sent as part of a chargeback transaction. In some embodiments, chargeback response messages are generated by a payment processing network on behalf of merchants enrolled in a chargeback insurance program. In scenarios where the merchant is not enrolled in the chargeback insurance program, the chargeback response message is generated in response to the chargeback request message by the merchant computer or the acquirer computer associated with the merchant. The chargeback response message is a message indicating approval or denial of a chargeback request and may be comprised of merchant account information and other details for the chargeback (e.g. basis of approval or denial, chargeback amount, etc.). In other embodiments, a merchant may detect fraudulent activity and initiate a chargeback process including generating a chargeback response message without receiving a chargeback request message. For example, a merchant may determine that a transaction was incorrectly charged to the user and initiate a process to credit an account associated with the user the amount of the incorrect charge.

In other embodiments, where the issuer is the party that enrolled in the chargeback insurance program, the chargeback response message may contain different data. For example, the chargeback response message may indicate to the issuer that the chargeback request was approved, but may not include an indication of the amount of the chargeback. In such embodiments, the payment processing network may store all the chargeback information and present it to the issuer computer at a later time (e.g. through a monthly account statement).

The term “user account data” may refer to data related to a user in a transaction. For example, user account data may include a user name, address, phone number, personal identification number (PIN), and account information for an account of the user associated with an issuer computer. In some embodiments, this data is contained in a chargeback request message sent from an issuer computer to the payment processing network as part of the chargeback approval process.

The term “merchant account data” may refer to data related to a merchant in a transaction. For example, merchant account data may include a merchant name, address, phone number, and account information for an account of merchant associated with an acquirer computer. In some embodiments, this data is contained in a chargeback request message sent from the payment processing network to the issuer computer as part of the chargeback transaction process, as well as during a clearing and settlement process.

The term “chargeback basis data” may refer data related to a chargeback. In some embodiments, the chargeback basis data may be contained in a portion of the chargeback request message. The chargeback basis data may be contained in the chargeback request message and may indicate a basis or reason for the chargeback request message. The chargeback basis data may be in the form of a reason code. Examples of chargeback basis data include, but are not limited to, fraudulent activity (e.g. the user alleges that they did not authorize the transaction), duplicate billing, incorrect amount billed, user claims to have not received the goods as promise at the time of the purchase. In some embodiments, the chargeback basis data may be divided into three categories of chargeback bases: fraud related, processing related, and service related. Other embodiments may include these chargeback bases, additional chargeback bases, or fewer chargeback bases.

Fraud related chargebacks may include transactions that were conducted fraudulently. Fraudulent transaction may occur when the person who conducted the transaction is not authorized by the user, including both transactions conducted in-person with a portable consumer device and transactions conducted through a client computer using a stolen portable consumer device or stolen details of a user's account. Fraud related chargebacks may also be the result of identity theft of the user resulting in a third party obtaining financial accounts (e.g. credit cards, financial account information) using the user's credentials.

Processing related chargebacks may include chargebacks based on issues from the processing of the transaction. For example, processing related chargebacks may include duplicate charges for a single order, incorrect amount charged to user's account, refund incorrectly or not processed, and transaction was declined by the issuer but still charged against the user's account.

Service related chargebacks may include chargebacks that are related to the fulfillment of the transaction. For example, service related chargebacks may include receiving goods different than described or ordered, receiving damaged or defective goods, receiving goods after a guaranteed delivery date, and not receiving the goods at all.

The term “merchant identification data” may refer to a data related to a merchant that can uniquely identify the merchant. In some embodiments, each merchant may have a unique merchant identifier that is transmitted in a chargeback request message to indicate the specific merchant that is the subject of the chargeback request, and in order to conduct the chargeback. Merchant identification data may also be transmitted by the merchant computer in a payment authorization request message. The merchant identification data may comprise an merchant ID, but may also be comprised of the merchant's name, address, phone number, and other identifying information. The merchant ID may be alphanumeric, letters only, or numerals only.

The term “chargeback amount” may refer to an amount of funds requested or processed in a chargeback transaction. In some embodiments, the chargeback amount is established by the issuer computer in a chargeback request message. In other embodiments, the chargeback amount may be determined by the user, or the acquirer computer based on the transaction from which the chargeback is being requested.

The term “enrolled merchant database” may refer to database storing enrollment data. In some embodiments, the enrolled merchant database stores the merchant identification data for all merchants enrolled in the chargeback insurance program. The enrolled merchant database may contain the name, merchant identifier, address, phone number, and merchant account data for all merchants enrolled in the chargeback insurance program. In some embodiments, the enrolled merchant database may also contain a record of all the chargebacks requested against each merchant enrolled in the chargeback insurance program.

The term “chargeback database” may refer to a database storing chargeback data. In some embodiments, the payment processing network may store all chargeback request messages and chargeback response messages that are evaluated and generated by the chargeback insurance program. In other embodiments, the payment processing network may store all chargeback request messages and chargeback response messages, regardless of whether the chargeback insurance program was implicated. In this manner, the payment processing network may keep a record of all chargeback transactions that occur. This data can be used to generate reports and can be evaluated in order to detect fraudulent chargeback activity.

The term “settlement file” may include a file that is generated and transmitted as part of transaction processing. A typical settlement file is a batch record containing one or more settlement records, where each settlement record contains payment information for authorized financial transactions. Settlement files are sent in order for a merchant to receive funds for the authorized financial transactions. Settlement files may also be sent for a user to receive funds for a chargeback transaction against the merchant. Settlement records within the settlement files are generally for credit card, debit card, or prepaid card transactions. Settlement files may be generated by a merchant computer or issuer computer or any other appropriate computer apparatus. The settlement file may be transmitted through an acquirer computer an issuer computer, or from the issuer computer to the acquirer computer. In some embodiments, the settlement file is sent from the issuer computer to a payment processing network. Settlement files are typically submitted for processing after the close of business for a merchant. Settlement files can also be submitted for processing throughout the day or submitted when their value reaches a desired threshold for processing. In some embodiments, settlement files may be a message requesting monetary funds in the amount of a transaction conducted by a user at a merchant.

The term “predetermined amount” may refer to a number of chargeback request messages established by a payment processing network. In some embodiments, the predetermined amount can be the maximum number of chargeback request messages against a merchant that the payment processing network will process under the chargeback insurance program. For example, the first 50 chargebacks a month are covered. In other embodiments, the predetermined amount can be a set monetary amount. For example, the chargeback insurance program may only cover the first $5,000 per month in chargeback request messages against a single merchant.

The term “monetary funds” may include any suitable type of value including dollars, Euros, virtual currency, etc.

The term “fraudulent chargeback activity” may refer to activity indicating fraudulent chargebacks. For example, fraudulent chargeback activity may include activity showing that a user has initiated repeated chargebacks against a merchant or a plurality of merchants. Similarly, if a particular merchant has a rate of chargebacks that is higher than comparable merchants, it may be an indication of fraudulent chargebacks being conducted against that particular merchant. In these embodiments, the payment processing network may determine an average or baseline chargeback rate for an individual user and for a particular merchant or merchant type, which may then be used as a comparison. Chargeback rates that occur at a significant deviation from the average or baseline rates may indicate fraudulent activity. In other embodiments, fraudulent chargeback activity may be indicated when the plurality of chargebacks request messages associated with a merchant exceed a predetermined amount. For example, the chargeback insurance program may establish that chargeback request messages received that exceed a daily, weekly, monthly, or yearly limit indicates fraudulent activity.

### I. Systems

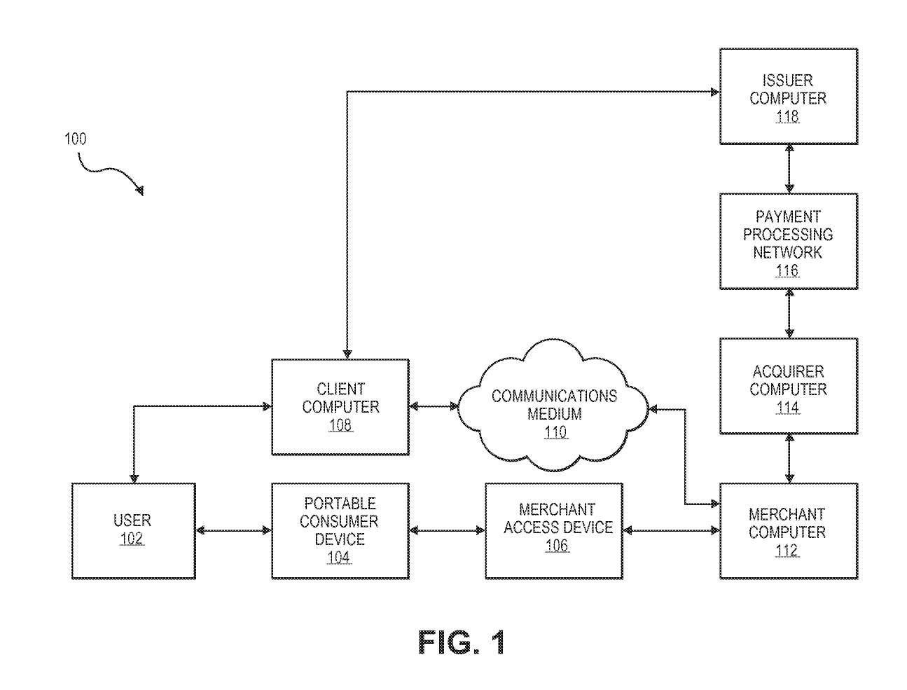

A system 100 for receiving and processing chargeback requests on behalf of a merchant, according to an embodiment of the present invention, is shown in FIG. 1.

The exemplary system 100 may include a user 102, a portable consumer device 104, a merchant access device 106, a client computer 108, a communications medium 110, a merchant computer 112, an acquirer computer 114, a payment processing network 116, and an issuer computer 118.

The user 102 may be an individual, or an organization such as a business, that is capable of conducting transactions for goods or services. The user 102 may further be an individual or business that has established a financial account with a financial institution. The typical user 102 is a user engaging in a transaction with a merchant for merchant goods and/or services.

The portable consumer device 104 may be in any suitable form. For example, suitable portable consumer devices 104 can be hand-held and compact so that it can fit into a user's wallet and/or pocket (e.g., pocket-sized). The portable consumer device 104 can include a processor, and memory, input devices, and output devices, operatively coupled to the processor. Specific examples of portable consumer devices 104 include cellular or wireless phones, personal digital assistants (PDAs), pagers, tablet computers, portable computers, smart cards, and the like. The portable consumer devices 104 can also be debit devices (e.g., a debit card), credit devices (e.g., a credit card), or stored value devices (e.g., a pre-paid or stored value card).

The client computer 108 may communicate with the merchant computer 112 via the communications medium 110, such as a network (e.g. the Internet). The client computer 108 may be in any suitable form. Examples of client computers 108 include any device capable of accessing the Internet, such as a personal computer, cellular or wireless phones, personal digital assistants (PDAs), tablet computers, and handheld specialized readers. In some embodiments of the invention, the portable consumer device 104 and the client computer 108 can be a single device.

The merchant computer 112 may be comprised of various modules that may be embodied by computer code, residing on computer readable media. It may include any suitable computational apparatus operated by a merchant. The merchant computer 112 may be in any suitable form. Examples of merchant computers 112 include any device capable of accessing the Internet, such as a personal computer, cellular or wireless phones, personal digital assistants (PDAs), tablet computers, and handheld specialized readers. The merchant computer 112 may transmit and receive data through the communications medium 110 with the client computer 108. The merchant computer 112 may also receive and transmit data to the merchant access device 106. In some embodiments of the invention, the merchant computer 112 receives transaction data from the client computer 108 or the merchant access device 106 and transmits the transaction data to the payment processing network 116 through an acquirer computer 114, for further transaction authorization processes.

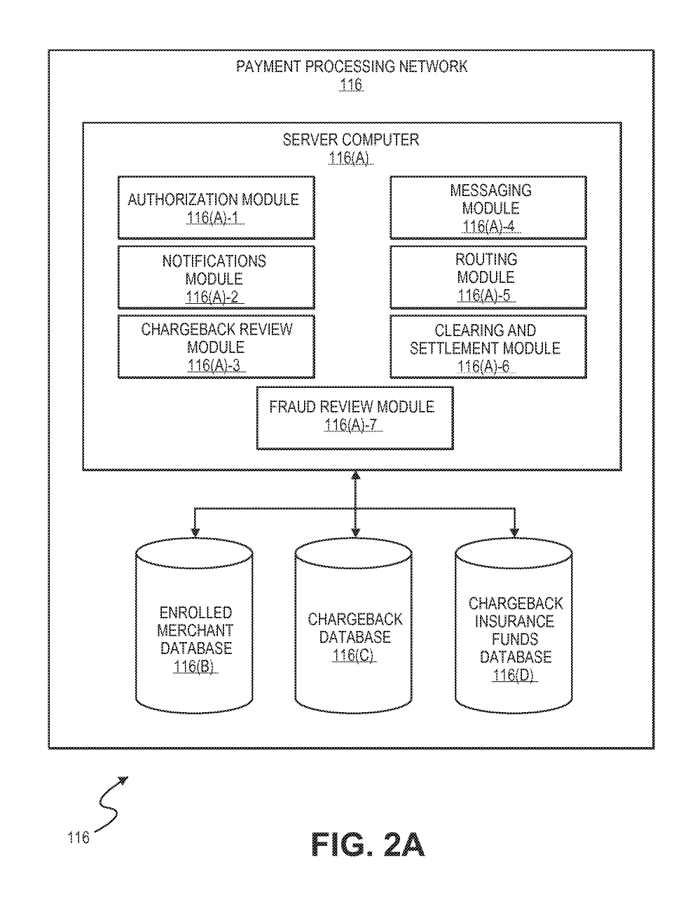

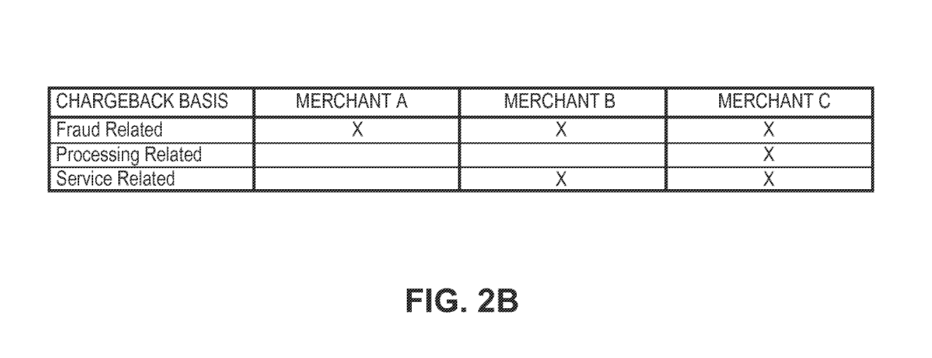

As depicted in FIG. 2A, the payment processing network 116 may comprise a server computer 116(A) comprising an authorization module 116(A)-1, a notifications module 116(A)-2, a chargeback review module 116(A)-3, a messaging module 116(A)-4, a routing module 116(A)-5, a clearing and settlement module 116(A)-6, and a fraud review module 116(A)-7. The various modules may be embodied by computer code, residing on computer readable media.

The payment processing network 116 may include data processing subsystems, networks, and operations used to support and deliver authorization services, exception file services, and clearing and settlement services. An exemplary payment processing network 116 may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The payment processing network 116 may use any suitable wired or wireless network, including the Internet.

The authorization module 116(A)-1 may process authorization request messages received by the payment processing network 116 from the acquirer computer 114 and determine the appropriate destination for the authorization request messages.

An authorization request message is a message sent requesting that an issuer computer 118 authorize a financial transaction. An authorization request message may comply with ISO 8583, which is a standard for systems that exchange electronic transactions made by users using payment devices. An authorization request message according to other embodiments may comply with other suitable standards. In some embodiments of the invention, an authorization request message may include, among other data, a Primary Account Number (PAN) and expiration date associated with a portable consumer device 104 (e.g. credit/debit card) of the user, amount of the transaction (which may be any type and form of a medium of exchange such a money or points), category identification of a merchant (e.g. merchant ID. In some embodiments, an authorization request message may be generated by a server computer (if the transaction is an e-commerce transaction) or by a merchant access device 106 (e.g. a point of sale (POS) device) (if the transaction is a brick and mortar type transaction) and is sent to an issuer computer 118 via the payment processing network 116 and the acquirer computer 114.

An authorization response message is a message sent from the issuer computer 118, in response to an authorization request message. The typical authorization response message includes an indication as to whether the authorization has been either approved or declined. An authorization response message may comply with ISO 8583, which is a standard for systems that exchange electronic transactions made by users using payment devices.

The notifications module 116(A)-2 may be configured to send notifications and alerts to the user 102. In some embodiments of the claimed invention, the notifications module 116(A)-2 may be configured to send notifications and alerts to the user 102 for transaction and chargeback related issues. For example, the notifications module 116(A)-2 may notify the user regarding successful processing of purchase transactions. The notifications module 116(A)-2 may also notify the user that a chargeback request has been successfully processed and that monetary funds have been credited to the user's account. The notifications and alert messages can be sent in real-time as the purchase transactions or chargeback transactions are occurring or can be sent after transaction processing has been completed. The notifications and alert messages can be in any suitable format. Examples of notifications and alert messages can include SMS messages, electronic mail messages, standard postal mail messages, or in any other suitable message format.

The chargeback review module 116(A)-3 may be configured to analyze chargeback request messages sent by the issuer computer 118 to the payment processing network 116. For example, upon receiving a chargeback request message for a transaction, the chargeback review module 116(A)-3 may be configured to parse the chargeback request message, evaluate the data contained in the chargeback request message, access the enrolled merchant database 116(B), and determine whether the merchant associated with the chargeback request message is enrolled in the chargeback insurance program. The chargeback review module 116(A)-3 may also be configured to process the chargeback request message depending on whether the merchant associated with the chargeback request message is enrolled in the chargeback insurance program. For example, when the merchant is enrolled in the chargeback insurance program, the chargeback review module 116(A)-3 may access the chargeback insurance funds database 116(D), retrieve data related to an account for handling chargebacks covered by the chargeback insurance program, and pass the data to the messaging module 116(A)-4 to generate a chargeback response message. In some embodiments, if the merchant is not enrolled in the chargeback insurance program, the chargeback review module 116(A)-3 may pass the chargeback request message to the routing module 116(A)-5 for forwarding to the appropriate acquirer computer 114 associated with the merchant.

The messaging module 116(A)-4 may send and receive authorization request messages and authorization response messages, as well as send, generate, and receive chargeback request messages and chargeback response messages. The messaging module 116(A)-4 may receive authorization request messages from and send authorization response messages to the acquirer computer 114, as well as send authorization request messages to and receive authorization response messages from the issuer computer 118. The messaging module 116(A)-4 may further receive chargeback request messages from the issuer computer 118. In some embodiments, the messaging module 116(A)-4 may generate chargeback response messages for chargeback transactions handled by the payment processing network 116. In other embodiments, the chargeback response messages are generated by the acquirer computer 114 and sent through the payment processing network 116 to the appropriate issuer computer 118.

The routing module 116(A)-5 may handle the routing of authorization request messages from the acquirer computer 114 to the issuer computer 118, and routing the authorization response messages back from the issuer computer 118 to the acquirer computer 114. The routing module 116(A)-5 may further handle the routing of clearing and settlement messages or files between the acquirer computer 114 and the issuer computer 118 related to the clearing and settlement process. The routing module 116(A)-5 may also handle the routing of chargeback request messages and chargeback response messages. In some embodiments, when the merchant is determined not to be enrolled in the chargeback insurance program, the routing module 116(A)-5 may route the chargeback request message to the appropriate acquirer computer 114.

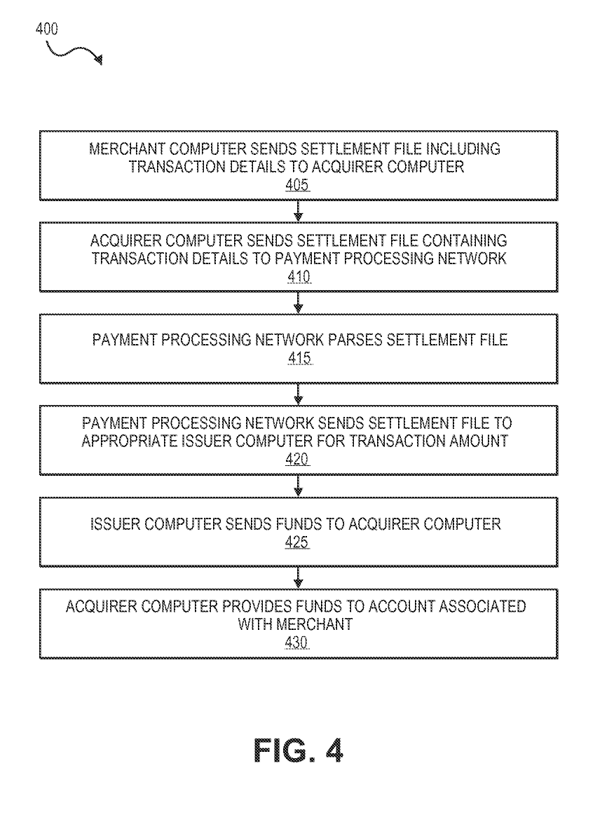

The clearing and settlement module 116(A)-6 may handle the clearing and settlement of transactions. The clearing and settlement module 116(A)-6 may authenticate user information and organize the settlement process of user accounts between the acquirer computer 114 and the issuer computer 118. An example of the clearing and settlement module 116(A)-6 is the Base II data processing system, which provides clearing, settlement, and other interchange-related services. Additional details regarding the clearing and settlement process for a transaction will be discussed with respect to FIG. 4.

The fraud review module 116(A)-7 may be configured to evaluate chargeback history to detect fraudulent activity. In some embodiments, the fraud review module 116(A)-7 may be configured to access the chargeback database 116(C), retrieve chargeback request messages processed by the payment processing network 116, and evaluate chargeback history. For example, the fraud review module 116(A)-7 may retrieve the chargeback history for a particular merchant. As the chargeback database 116(C) maintains a history of all chargebacks initiated against the particular merchant, the fraud review module 116(A)-7 may be able to detect fraudulent chargeback activity. For example, the fraud review module 116(A)-7 may determine and review the rate of chargebacks for a particular merchant compared to comparable merchants, may determine that a particular user has initiated a significant number of chargebacks against the particular merchant or a plurality of merchants, and/or may determine any other indications of fraudulent activity.

For example, the fraud review module 116(A)-7 may review chargeback history and determine, based on predetermined criteria, that a particular user has conducted a significant number of chargebacks. Further, the fraud review module 116(A)-7 may determine that a merchant has been subjected to a significant number of fraud-based chargebacks, which may indicate that the particular merchant may need to re-evaluate its transaction processing method. In addition, if a merchant enrolled in the chargeback insurance program has a significant number of chargebacks that were covered by the chargeback insurance program, the payment processing network 116 may consider re-evaluating the premiums, fee or deductibles it charges the merchant for enrollment.

As noted above, the payment processing network 116 may have or operate at least a server computer 116(A). In some embodiments, the server computer 116(A) may be coupled to a database and may include any hardware, software, other logic, or combination of the preceding for servicing the requests from one or more client computers. The one or more databases may comprise an enrolled merchant database 116(B), a chargeback database 116(C), and a chargeback insurance funds database 116(D). The server computer 116(A) may comprise one or more computational apparatuses and may use any of a variety of computing structures, arrangements, and compilations for servicing the requests from one or more client computers.

The enrolled merchant database 116(B) may store a merchant profile for each merchant that enrolls in a chargeback insurance program offered by the payment processing network 116. In some embodiments, when a chargeback request message is received by the payment processing network 116, the chargeback review module 116(A)-3 queries the enrolled merchant database 116(B) to determine whether the merchant ID contained in the chargeback request message matches the merchant ID of a merchant in the enrolled merchant database. If there is a match, the merchant has been determined as being enrolled in the chargeback insurance program. In some embodiments, the enrolled merchant database 116(B) may also be comprised of a table containing merchant enrollment choices, as depicted in FIG. 2B.

The chargeback database 116(C) may store a record of each chargeback request message that is processed through the payment processing network 116. The chargeback database 116(C) may further store the result of each chargeback request, including the contents of each corresponding chargeback response message, whether generated by the payment processing network 116 or the acquirer computer 114. Thus, in some embodiments, the chargeback database 116(C) stores all chargeback request messages and chargeback response messages regardless of whether the chargeback was processed through the chargeback insurance program. In other embodiments, the chargeback database 116(C) may only store chargeback request messages processed by the chargeback insurance program.

The chargeback insurance funds database 116(D) may store the records for a financial account associated with the payment processing network 116 that is used to process chargeback requests. For example, when the merchant ID associated with a received chargeback request message matches a merchant ID associated with a merchant profile stored in the enrolled merchant database 116(B), the chargeback insurance funds database 116(D) may be accessed by the chargeback review module 116(A)-3.

Referring again to FIG. 1, the acquirer computer 114 is typically a system for an entity (e.g. a bank) that has a business relationship with a particular merchant or other entity. An issuer computer 118 is typically a business entity (e.g. a bank) which maintains financial accounts for the user 102. The issuer computer can also issue the portable consumer device 104, such as a credit or debit card to the user 102. Some entities can perform both issuer computer 114 and acquirer computer 118 functions. Embodiments of the invention encompass such single entity issuer-acquirers.

### II. Methods

Methods according to embodiments of the invention can be described with respect to FIGS. 1-8.

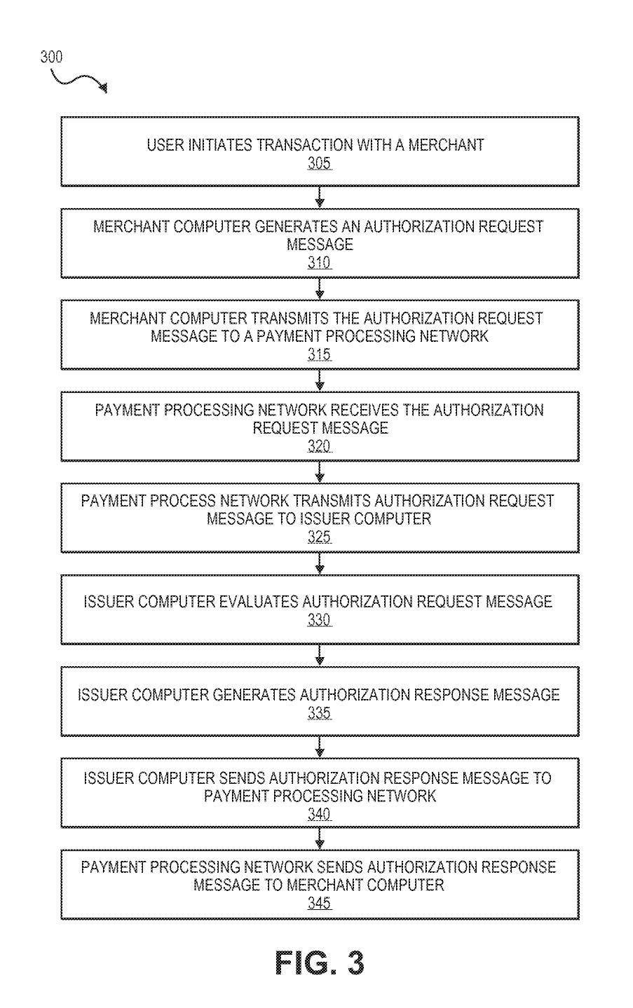

FIG. 3 is a flowchart of a method 300 for conducting a financial transaction between a user and a merchant according to an embodiment of the claimed invention using a system 100 shown in FIG. 1.

In step 305, a user 102 initiates a transaction with a merchant. In a typical transaction, the user 102 engages in a transaction for goods or services at a merchant associated with a merchant computer 112 using a client computer 108 through a communications medium 110, such as the Internet. For example, the user 102 may use a client computer 108 in the form of an Internet-enabled mobile phone to access a merchant website to conduct a transaction. In other embodiments, the user 102 may conduct the transaction using a portable consumer device 104 interacting with a merchant access device 106. For example, the user 102 may swipe a portable consumer device 104 in the form of a credit card through a merchant access device 106 (e.g. POS terminal) or, in another embodiment, may take a portable consumer device 104 in the form of a wireless phone and pass it near a contactless reader in a POS terminal.

In step 310, the merchant computer 310 generates an authorization request message containing transaction details, which may include but is not limited to, transaction amount, merchant identifier, transaction items, date and time of the transaction, user payment method, user billing address, user shipping address, user phone number, etc. The authorization request message may be generated by either a web server in the merchant computer 112, or by a merchant access device 106 (e.g. a POS terminal) and sent to the merchant computer 112. The authorization request message may be generated in any suitable format. The authorization request message may comply with ISO 8583, which is a standard for systems that exchange electronic transactions made by users using portable consumer devices 104. Authorization request messages according to other embodiments may comply with other suitable standards.

In step 315, the merchant computer 112 transmits the authorization request message to a payment processing network 116. The authorization request message may be transmitted to the payment processing network 116 by the merchant computer 112 through an acquirer computer 114. The authorization request message may be transmitted in any suitable format.

In step 320, the payment processing network 116 receives the authorization request message. The payment processing network 116 receives the authorization request message requesting authorization to conduct a transaction for a transaction between the user 102 and the merchant computer 112. A messaging module 116(A)-4 may receive authorization request messages from the acquirer computer 114 and send authorization request messages to the issuer computer 118. A transaction review module 116(A)-2 may parse the authorization request message to determine the appropriate issuer computer 118 to send the authorization request message to. In other embodiments, the authorization module 116(A)-1 may review the authorization request message and generate an authorization response message for the transaction on behalf of the issuer computer 118.

In step 325, the payment processing network 116 transmits the authorization request message to the issuer computer 118. After receiving the authorization request message, the payment processing network 116 may then transmit the authorization request message to an appropriate issuer computer 118 associated with the portable consumer device 104 or a user account used for the transaction via the client computer 108. In some embodiments, the routing module 116(A)-5 routes the authorization request message to the appropriate issuer computer 118, based on the contents of the authorization request message.

In step 330, the issuer computer 118 evaluates the authorization request message. The issuer computer 118 receives the authorization request message requesting authorization for a transaction being conducted between the user 102 and the merchant. The issuer computer 118 may evaluate the contents of the authorization request message to determine whether the transaction should be authorized.

In step 335, the issuer computer 118 generates an authorization response message. The issuer computer 118 generates the authorization response message and transmits the authorization response message to the payment processing network 116. The authorization response message can indicate whether the transaction contained in the authorization request message has been authorized or has been declined by the issuer computer 118. The authorization response message may be generated in any suitable format. The authorization response message may comply with ISO 8583, which is a standard for systems that exchange electronic transactions made by users using portable consumer devices 104. Authorization response messages according to other embodiments may comply with other suitable standards.

In step 340, the issuer computer 118 sends authorization response message to the payment processing network 116. The issuer computer 118 can send the authorization response message to the payment processing network 116. The message may be sent by an appropriate messaging means.

In step 345, the payment processing network 116 sends the authorization response message to the merchant computer 112. The payment processing network 116 may send the authorization response message back to the acquirer computer 114, which may then transmit the authorization response message back to the merchant computer 112. The merchant computer 112 may parse the authorization response message. If the transaction was approved, the merchant computer 112 may store the transaction data in a reconciliation file for future clearing and settlement processes. In some embodiments, the reconciliation file is stored at the payment processing network 116.

FIG. 4 is a flowchart of a method 400 of clearing and settling a financial transaction according to an embodiment of the claimed invention using a system 100 shown in FIG. 1.

In step 405, the merchant computer 112 sends the settlement file including transaction details to the acquirer computer 114. The merchant computer 112 may provide the settlement file containing transaction details to the acquirer computer 114. The settlement file may contain a reconciliation file containing all the transaction details for transactions conducted between the user 102 and the merchant. The transaction may have been conducted through either the user 102 using a client computer 108 to access a website hosted by a merchant computer 112 through a communications medium 110, or by the user 102 using a portable consumer device 104 to interact with a merchant access device 106 (e.g. a POS terminal). In either scenario, the merchant computer 112 will send the settlement file to an acquirer computer 114 containing transactions. The settlement file may be submitted periodically throughout the day, or more commonly, at the end of the business day.

A clearing and settlement process may include a process of reconciling a transaction. A clearing process is a process of exchanging financial details between an acquirer computer 114 and an issuer computer 118 to facilitate posting to an account and reconciliation of the user's settlement position. Settlement involves the delivery of securities from one user to another. In some embodiments, clearing and settlement can occur simultaneously. In some embodiments, the settlement process can be conducted using standard financial transaction messaging formats.

For example, standard BASE II settlement records or Single Message System (SMS) messages may be used. BASE II is a data processing network operated by VISA for the clearing and settlement of payment device transactions between payment device—honoring merchant acquirers and payment device issuers. This system can provide net daily account settlement among VISA member institutions.

In step 410, the acquirer computer 114 sends the settlement file containing the transaction details, to the payment processing network 116. After the acquirer computer 114 associated with a merchant receives the settlement file containing the transactions of the user 102 from the merchant computer 112, the acquirer computer 114 routes the settlement file to the payment processing network 116. The payment processing network 116 receives the settlement file comprising the reconciliation file and transaction details.

In step 415, the payment processing network 116 parses the settlement file. The payment processing network 116 evaluates the contents of the settlement file and determines the appropriate issuer computer 118 to which the settlement file should be transmitted. In some embodiments of the claimed invention, the clearing and settlement module 116(A)-6 in the payment processing network 116 determines the appropriate issuer computer 118 to send the settlement file based on the contents of the settlement file. For example, the clearing and settlement module 116(A)-6 may parse out user account information contained (e.g. account number, financial institution information, etc.), in the settlement file and pass the settlement file to the routing module 116(A)-5 for transmission to the appropriate issuer computer 118 associated with the user 102.

In step 420, the payment processing network 116 sends the settlement file to the appropriate issuer computer 118 for the transaction amount. The routing module 116(A)-5 in the payment processing network 116 may route the settlement file to the appropriate issuer computer 118 for the user's account using the messaging module 116(A)-4 and the routing module 116(A)-5. The payment processing network 116 can send the settlement file to the issuer computer 118 by any appropriate messaging means. The issuer computer 118 receives the settlement file comprising transaction details.

In step 425, the issuer computer 118 sends funds to the acquirer computer 114. The issuer computer 118 initiates the transfer of funds from an account of the user 102 to the merchant. After receiving the settlement file at the issuer computer 118, the issuer computer 118 parses the settlement file, locates the appropriate user account for the transaction, and charges the transaction amount against the appropriate user account as an actual purchase. In some embodiments, the issuer computer 118 initiates the process by debiting the transaction amount from the account (or by charging the account an amount equal to the transaction amount). Once the transaction amount is charged against the appropriate user account, the issuer computer 118 transmits the funds back to the acquirer computer 114 via the payment processing network 116.

In step 430, the acquirer computer 114 provides funds to an account associated with the merchant. Once the acquirer computer 114 receives the funds from the issuer computer 118, the acquirer computer 114 credits an account associated with the merchant with the transaction amount. In some embodiments, the acquirer computer may generate a notification message to the merchant computer 112 indicate success or failure of the clearing and settlement process. In other embodiments, the acquirer computer may store all the transaction information and present it to the user at a later time (e.g. through a monthly billing statement).

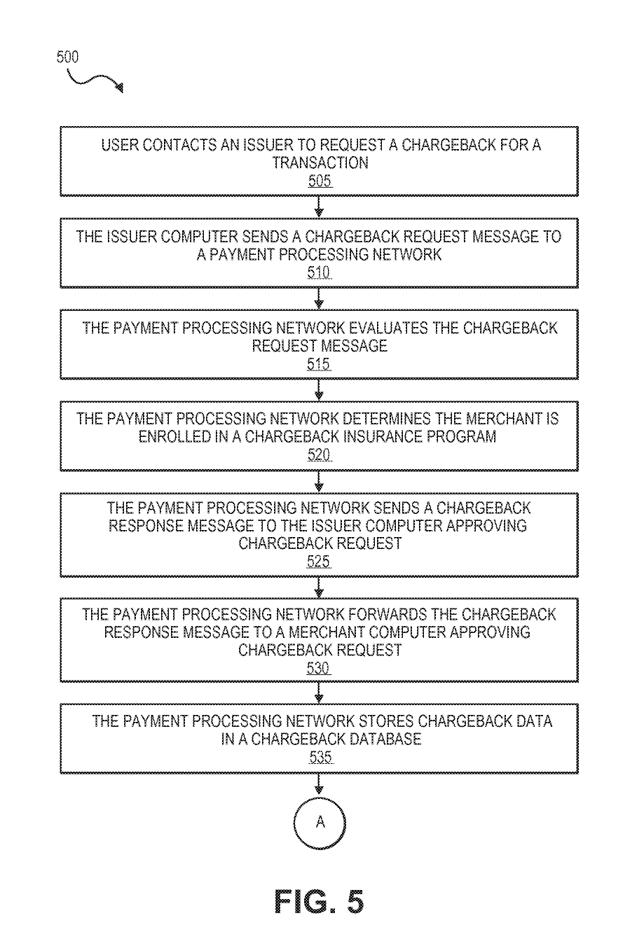

FIG. 5 is a flowchart of a method 500 of processing a chargeback request for a merchant enrolled in a chargeback insurance program, according to an embodiment of the claimed invention using a system 100 shown in FIG. 1.

In step 505, a user 102 contacts an issuer to request a chargeback for a transaction. In some embodiments, the user 102 may contact the issuer of a user account associated with the transaction to request that a chargeback be initiated for the transaction. The user 102 may have determined that the transaction was fraudulently conducted by another individual, or the user 102 may have a problem with the transaction justifying a chargeback (e.g. non-receipt of goods or services, duplicate charge, etc.). In some embodiments, the user 102 may contact the issuer by phone, electronic mail, or through accessing an issuer computer 118 via a client computer 108.

In step 510, the issuer computer 118 sends a chargeback request message to a payment processing network 116. The issuer computer 118 may evaluate the request from the user 102 to initiate a chargeback. The issuer computer 118 may then generate a chargeback request message. In some embodiments, the chargeback request message may be comprised of, at least, transaction details for the transaction the chargeback is sought against, account data for a user account associated with the transaction, chargeback basis data, merchant identification data (e.g. a merchant identifier), and a chargeback amount. The issuer computer 118 may then send the generated chargeback request message to the payment processing network 116.

In step 515, the payment processing network 116 evaluates the chargeback request message. The payment processing network 116 receives the chargeback request message from the issuer computer 118. A chargeback review module 116(A)-3 in the payment processing network 116 may then evaluate the chargeback request message by parsing out details from the chargeback request message. For example, the chargeback review module 116(A)-3 in the payment processing network 116 may determine a merchant associated with the chargeback request message by retrieving a merchant identifier from the chargeback request message.

In step 520, the payment processing network 116 determines the merchant is enrolled in a chargeback insurance program. In some embodiments, the chargeback review module 116(A)-3 determines the merchant associated with the chargeback request message by retrieving a merchant ID contained in the chargeback request message. The chargeback review module 116(A)-3 may then determine whether the merchant ID is contained in an enrolled merchant database 116(B). The enrolled merchant database 116(B) may contain a record or merchant profile for all merchants enrolled in the chargeback insurance program offered by the payment processing network 116.

In some embodiments, the merchant's enrollment in the chargeback insurance program may be based on established chargeback bases. For example, chargeback bases may fraud related, processing related, or service related. In other embodiments, there may be fewer or additional chargeback bases. Each merchant enrolled in the chargeback insurance program can customize its enrollment in the chargeback insurance program to cover chargeback to one or more of the provided chargeback bases. An example of a table comprised of merchant enrollment data is depicted in FIG. 2B. The data contained in the table may be stored in the merchant profile in the enrolled merchant database 116(B).

As depicted in the example in FIG. 2B, merchant A's enrollment in the chargeback insurance program covers fraud related chargebacks, merchant B's enrollment covers fraud related and service related chargebacks, and merchant C's enrollment covers fraud related, processing related, and service related chargebacks.

In step 525, the payment processing network 116 sends a chargeback response message to the issuer computer 118 approving the chargeback request. Once the payment processing network 116 has determined that the merchant ID contained in the chargeback request message is enrolled in the chargeback insurance program, a messaging module 116(A)-4 in the payment processing network 116 may generate a chargeback response message indicating approval of the chargeback request. The payment processing network 116 may then send the chargeback response message to the issuer computer 118.

The chargeback response message may be a message indicating approval or denial of a chargeback request and may be comprised of merchant account information and other details for the chargeback (e.g. basis of approval or denial, chargeback amount, etc.). In other embodiments, where the issuer is the party that enrolled in the chargeback insurance program, the chargeback response message may contain different data. For example, the chargeback response message may indicate to the issuer that the chargeback request was approved, but may or may not include an indication of the amount of the chargeback. In such embodiments, the payment processing network may store all the chargeback information and present it to the issuer computer 118 at a later time (e.g. through a monthly account statement).

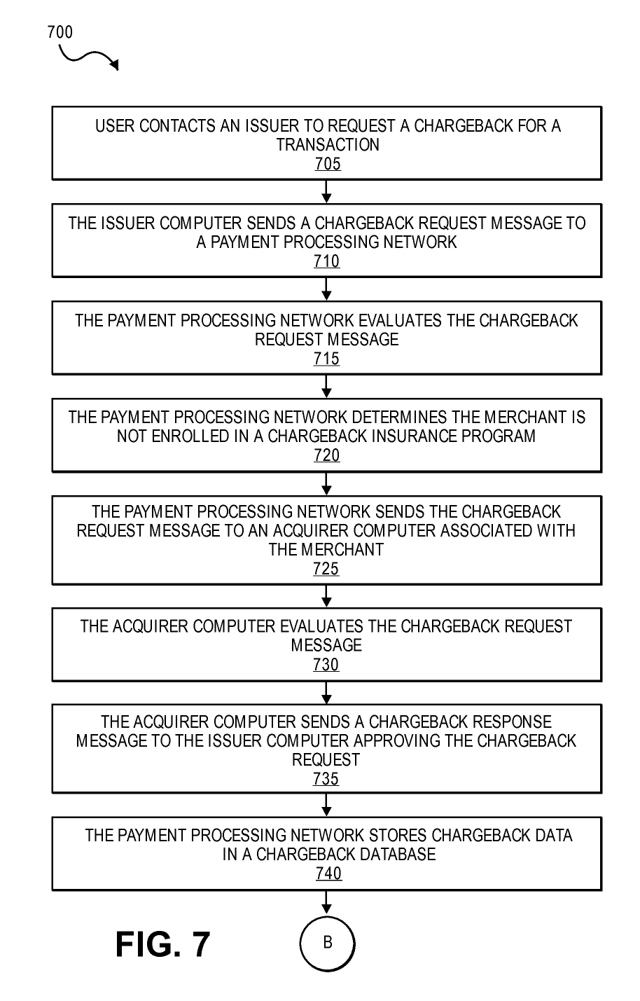

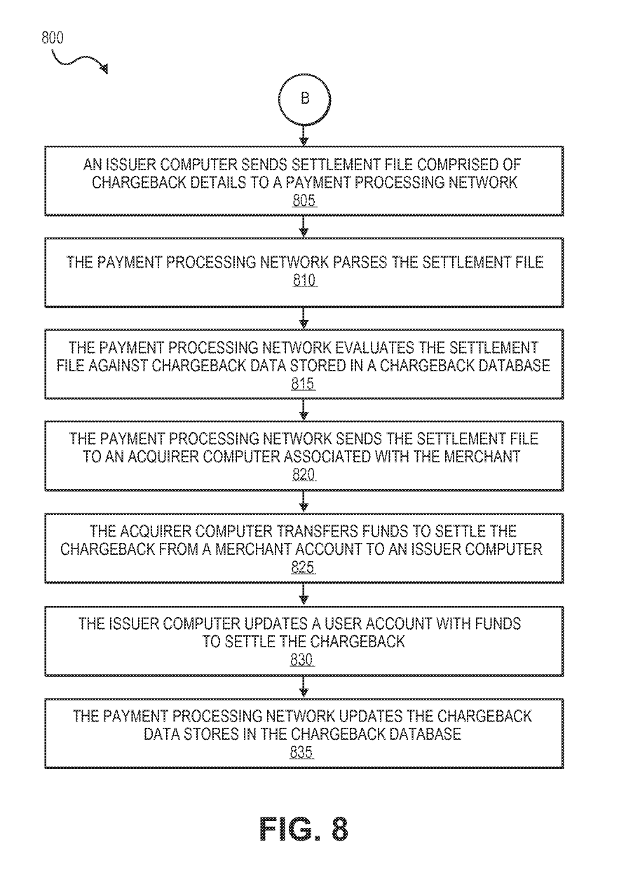

In some embodiments, after the payment processing network 116 determines the merchant is enrolled in the chargeback insurance program, the payment processing network 116 may evaluate the chargeback basis data contained in the chargeback request message. In such embodiments, for example, where the merchant is enrolled in the chargeback insurance program for just fraud-related chargebacks, when the chargeback basis data indicates that the chargeback request was fraud-based (e.g. the transaction was fraudulent conducted without the consent of the user 102), the chargeback insurance program is invoked. In such embodiments, when the chargeback basis data indicates that the chargeback request was not fraud-based (e.g. non-receipt of goods, overcharged, etc.), the chargeback insurance program may not be invoked and the chargeback request process will proceed in a manner similar to that described with respect to FIGS. 7 and 8. Similar scenarios may occur with chargebacks with different chargeback bases.

In step 530, the payment processing network 116 forwards the chargeback response message to a merchant computer 112 approving the chargeback request. In some embodiments, once the payment processing network 116 has generated and sent the chargeback response message to the issuer computer 118, the chargeback response message may also be sent to the merchant computer 112 associated with the chargeback. The chargeback response message may be sent by the payment processing network 116 to the merchant computer 112 via an acquirer computer 114 by the routing module 116(A)-5. In some embodiments, the chargeback response message is sent to the merchant computer 112 to indicate that a chargeback was processed by the chargeback insurance program on behalf of the merchant associated with the merchant computer 112.

In other embodiments, a notifications module 116(A)-2 in the payment processing network 116 may generate a notification message indicating that a chargeback was processed by the chargeback insurance program on behalf of the merchant. The notification message may then be sent by the payment processing network 116 to the merchant computer 112 via an acquirer computer 114 by the routing module 116(A)-5.

In other embodiments, no message or notification is sent to the merchant computer. The chargeback transaction details may be sent to the merchant on a periodic basis (e.g. a monthly statement).

In step 535, the payment processing network 116 stores the chargeback data in a chargeback database 116(C). Once the payment processing network 116 has generated and sent the chargeback response message, the payment processing network 116 may store a record of the chargeback data related to the chargeback in a database. In some embodiments, the payment processing network 116 may store the chargeback data in the chargeback database 116(C). The payment processing network 116 may also store the chargeback data to indicate that the chargeback process for the chargeback is still in process as the clearing and settlement process has not occurred. In other embodiments, the payment processing network 116 may store the chargeback data in the enrolled merchant database 116(B), when the chargeback data relates to a merchant enrolled in the chargeback insurance program. The payment processing network 116 may store details for the chargeback, the outcome of the chargeback request (e.g. whether it was processed by the chargeback insurance program or transmitted to the acquirer computer 114 for processing and approval.

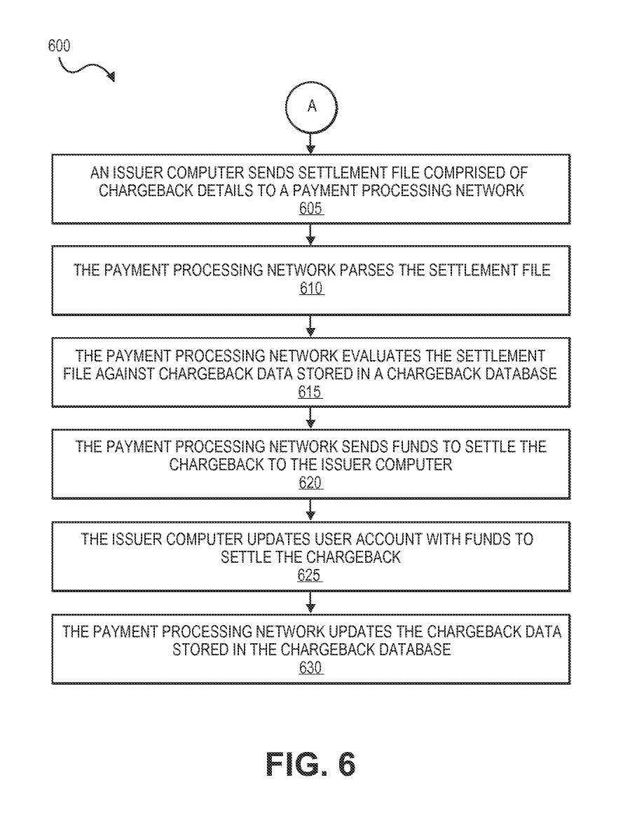

FIG. 6 is a flowchart of a method 600 of clearing and settling the chargeback request processed in FIG. 5, according to an embodiment of the claimed invention using a system 100 shown in FIG. 1.

In step 605, an issuer computer 118 sends settlement file comprised of chargeback details to a payment processing network 116. The issuer computer 118 may provide the settlement file containing chargeback details to the payment processing network 116. The settlement file may contain a reconciliation file containing all the details for chargebacks to be processed for accounts held by the issuer computer 118. In some embodiments, the issuer computer 118 will send the settlement file to a payment processing network 116 for evaluation and further processing. The settlement file may be submitted periodically throughout the day, or more commonly, at the end of the business day.

In step 610, the payment processing network 116 parses the settlement file. The payment processing network 116 receives the settlement file and a chargeback review module 116(A)-3 in the payment processing network 116 may parse out details for the chargeback. For example, the settlement file may include user data, merchant data, transaction data, and data contained in a chargeback response message that was previously sent to the issuer computer 118. The data from the chargeback response message may indicate the outcome of the chargeback request, including, but not limited to, the determination of whether the chargeback was covered by a chargeback insurance program offered by the payment processing network 116.

In step 615, the payment processing network 116 evaluates the settlement file against chargeback data stored in a chargeback database 116(C). In some embodiments, as the payment processing network 116 previously stored chargeback data in the chargeback database 116(C), the data corresponding to the chargeback data may be accessed and reviewed. In some embodiments, this may be done by the payment processing network 116 to review the contents of the chargeback response message corresponding to the chargeback to determine whether the chargeback insurance program is responsible for settling the chargeback.

In step 620, the payment processing network 116 sends funds to settle the chargeback to the issuer computer 118. Once the payment processing network determines that the chargeback details in the settlement file and the chargeback data in the chargeback database 116(C) indicate that the chargeback insurance program is responsible for settling the chargeback, a clearing and settlement module 116(A)-6 in the payment processing network 116 may retrieve funds to settle the chargeback. In some embodiments, the clearing and settlement module 116(A)-6 may access a chargeback insurance funds database 116(D) that contains account details for a financial account associated with the chargeback insurance program.

In step 625, the issuer computer 118 updates user account with the funds to settle the chargeback. Once the issuer computer 118 receives the funds from the payment processing network 116, the issuer computer 118 credits an account associated with the user with the chargeback amount. In some embodiments, the issuer computer 118 may generate a notification message to the user 102 indicating that the clearing and settlement process for the chargeback has been completed successfully. In other embodiments, the issuer computer 118 may store all the transaction information and present it to the user at a later time (e.g. through a monthly billing statement).

In step 630, the payment processing network 116 updates the chargeback data stored in the chargeback database 116(C). Once the payment processing network 116 has sent the funds to settle the chargeback to the issuer computer 118, the payment processing network 116 may update a record for the chargeback in the chargeback database 116(C). The payment processing network 116 may update the record for the chargeback in order to indicate that the clearing and settlement process for the chargeback has been successfully completed.

FIG. 7 is a flowchart of a method 700 of processing a chargeback request for a merchant that is not enrolled in a chargeback insurance program, according to an embodiment of the claimed invention using a system 100 shown in FIG. 1.

In step 705, a user 102 contacts an issuer to request a chargeback for a transaction. In some embodiments, the user 102 may contact the issuer of a user account associated with the transaction to request that a chargeback be initiated for the transaction. The user 102 may have determined that the transaction was fraudulently conducted by another individual, or the user 102 may have a problem with the transaction justifying a chargeback (e.g. non-receipt of goods or services, duplicate charge, etc.). In some embodiments, the user 102 may contact the issuer by phone, electronic mail, or through accessing an issuer computer 118 via a client computer 108.

In step 710, the issuer computer 118 sends a chargeback request message to a payment processing network 116. The issuer computer 118 may evaluate the request from the user 102 to initiate a chargeback. The issuer computer 118 may then generate a chargeback request message. In some embodiments, the chargeback request message may be comprised of, at least, transaction details for the transaction the chargeback is sought against, account data for a user account associated with the transaction, chargeback basis data, merchant identification data (e.g. a merchant identifier), and a chargeback amount. The issuer computer 118 may then send the generated chargeback request message to the payment processing network 116.

In step 715, the payment processing network 116 evaluates the chargeback request message. The payment processing network 116 receives the chargeback request message from the issuer computer 118. A chargeback review module 116(A)-3 in the payment processing network 116 may then evaluate the chargeback request message by parsing out details from the chargeback request message. For example, the chargeback review module 116(A)-3 in the payment processing network 116 may determine a merchant associated with the chargeback request message by retrieving a merchant identifier from the chargeback request message.

In step 720, the payment processing network 116 determines the merchant is not enrolled in a chargeback insurance program. In some embodiments, the chargeback review module 116(A)-3 determines the merchant associated with the chargeback request message by retrieving a merchant ID contained in the chargeback request message. The chargeback review module 116(A)-3 may then determine whether the merchant ID is contained in an enrolled merchant database 116(B). When the chargeback review module 116(A)-3 does not find a matching merchant ID in the enrolled merchant database 116(B), it is an indication that the merchant associated with the chargeback request message is not enrolled in the chargeback insurance program. The enrolled merchant database 116(B) may contain a record or merchant profile for all merchants enrolled in the chargeback insurance program offered by the payment processing network 116.

In step 725, the payment processing network 116 sends the chargeback request message to an acquirer computer 114 associated with the merchant. In some embodiments, when the chargeback review module 116(A)-3 determines that the merchant is not enrolled in the chargeback insurance program, the payment processing network 116 may send the chargeback request message to the acquirer computer 114 associated with the merchant. The chargeback request message may be routed to the acquirer computer by a routing module 116(A)-5 based on the contents of the chargeback request data.

In step 730, the acquirer computer 114 evaluates the chargeback request message. The acquirer computer 114 may receive the chargeback request message from the payment processing network 116 and evaluate its content. In some embodiments, the acquirer computer 114 may verify that the merchant ID in the chargeback request message has an account with the acquirer computer 114. In some embodiments, the acquirer computer 114 may determine whether the merchant's account has sufficient funds that can be debited to settle the amount of the chargeback.

In step 735, the acquirer computer 114 sends a chargeback response message to the issuer computer 118 approving the chargeback request. Once the acquirer computer 114 has determined that the merchant ID contained in the chargeback request message has an account with the acquirer computer 114, the acquirer computer 114 may generate a chargeback response message indicating approval of the chargeback request. The acquirer computer 114 may then send the chargeback response message to the issuer computer 118 through the payment processing network 116.

In step 740, the payment processing network 116 stores chargeback data in a chargeback database 116(C). In some embodiments, where the payment processing network 116 does not process the chargeback request message through the chargeback insurance program, the payment processing network 116 may store the details of the chargeback in a chargeback database 116(C). The payment processing network 116 may also store the chargeback data to indicate that the chargeback process for the chargeback is still in process as the clearing and settlement process has not occurred. The payment processing network 116 may store details for the chargeback (user data, merchant data, transaction data), and the outcome of the chargeback request (e.g. whether it was processed by the chargeback insurance program or transmitted to the acquirer computer 114 for processing and approval).

In some embodiments, this data is stored in the chargeback database 116(C) to provide the payment processing network 116 with a more complete history of chargebacks that were processed by and/or transmitted to the payment processing network 116. This may enable the payment processing network 116 to conduct reviews of the chargeback history of a user 102 and a merchant to evaluate potential fraudulent activity.

FIG. 8 is a flowchart of a method 800 of clearing and settling the chargeback request processed in FIG. 7, according to an embodiment of the claimed invention using a system 100 shown in FIG. 1.

In step 805, an issuer computer 118 sends settlement file comprised of chargeback details to a payment processing network 116. The issuer computer 118 may provide the settlement file containing chargeback details to the payment processing network 116. The settlement file may contain a reconciliation file containing all the details for chargebacks to be processed for accounts held by the issuer computer 118. In some embodiments, the issuer computer 118 will send the settlement file to a payment processing network 116 for evaluation and further processing. The settlement file may be submitted periodically throughout the day, or more commonly, at the end of the business day.

In step 810, the payment processing network 116 parses the settlement file. The payment processing network 116 receives the settlement file and a chargeback review module 116(A)-3 in the payment processing network 116 may parse out details for the chargeback. For example, the settlement file may include user data, merchant data, transaction data, and data contained in a chargeback response message that was previously sent to the issuer computer 118. The data from the chargeback response message may indicate the outcome of the chargeback request, including, but not limited to, the determination of whether the chargeback was covered by a chargeback insurance program offered by the payment processing network 116.

In step 815, the payment processing network 116 evaluates the settlement file against chargeback data stored in a chargeback database 116(C). In some embodiments, the payment processing network 116 stored chargeback data in the chargeback database 116(C) during the chargeback request and response process. The chargeback data in the chargeback database 116(C) may then be accessed and reviewed. In some embodiments, this may be done by the payment processing network 116 to review the contents of the chargeback response message corresponding to the chargeback to determine whether the chargeback insurance program is responsible for settling the chargeback.

In step 820, the payment processing network 116 sends the settlement file to an acquirer computer 114 associated with the merchant. In some embodiments, when the payment processing network 116 determines that the chargeback did not involve a merchant enrolled in the chargeback insurance program, the payment processing network 116 may forward the settlement file to the acquirer computer 114 associated with the merchant. In some embodiments, even if the merchant is enrolled in the chargeback insurance program, the payment processing network 116 may still send the settlement file to the acquirer computer 114 for funds retrieval, if the chargeback basis is not covered by the merchant's enrollment, the merchant may be responsible for the chargeback.

In step 825, the acquirer computer 114 transfers funds to settle the chargeback from a merchant account to the issuer computer 118. The acquirer computer 114 initiates the transfer of funds from an account of the merchant to the user 102. After receiving the settlement file at the acquirer computer 114, the acquirer computer 114 parses the settlement file, locates the appropriate merchant account for the transaction, and debits the chargeback amount from the merchant account. Once the chargeback amount is charged against the appropriate user account, the acquirer computer 114 transmits the funds back to the issuer computer 118 through the payment processing network 116.

In step 830, the issuer computer 118 updates a user account with funds to settle the chargeback. Once the issuer computer 118 receives the funds from the acquirer computer 114, the issuer computer 118 credits an account associated with the user with the chargeback amount. In some embodiments, the issuer computer 118 may generate a notification message to the user 102 indicating that the clearing and settlement process for the chargeback has been completed successfully. In other embodiments, the issuer computer 118 may store all the transaction information and present it to the user at a later time (e.g. through a monthly billing statement).

In step 835, the payment processing network 116 updates the chargeback data stored in the chargeback database 116(C). Once the payment processing network 116 has sent the funds to settle the chargeback to the issuer computer 118, the payment processing network 116 may update a record for the chargeback in the chargeback database 116(C). The payment processing network 116 may update the record for the chargeback in order to indicate that the clearing and settlement process for the chargeback has been successfully completed. This process may be conducted even when the chargeback was not covered by the chargeback insurance program, to allow the payment processing network 116 to maintain a more complete record of chargebacks processed through the payment processing network 116.

### III. Technical Benefits

Embodiments of the invention provide the technical benefits of efficiency and conserving resources. As chargebacks for merchants enrolled in a chargeback insurance program can be handled by a payment processing network without the need to send the chargeback request message to an acquirer computer and a merchant computer, both network resources and the time to send the chargeback request message to and receive a chargeback response from the acquirer computer and the merchant computer is conserved. Further, by utilizing existing systems and messaging capabilities, but implementing new methods of control and logic at payment processing networks, the systems and methods described do not require infrastructure changes in order to implement. Using a chargeback insurance program conducted by the payment processing network requires fewer steps and utilizes fewer resources.

Embodiments of the invention have a number of advantages. For example, merchants are provided predictability and security based on the knowledge its finances will not be affected by fraud-related chargebacks. This incentivizes a merchant to enroll in the chargeback insurance program. Additionally, by monitoring the chargeback request data through the payment processing network, fraud and abuse of the chargeback insurance program can be more readily detected.

In addition, enrolling in chargeback insurance through the payment processing network instead of a third party is convenient for the merchant, since the merchant will deal with one less entity. Further, the payment processing network may be involved in processing both an initial transaction and a chargeback transaction. This may provide greater security and fraud detection of fraudulent chargeback than a third party chargeback insurance provider that does not participate in the initial transaction can provide.

### IV. Additional Embodiments

In other embodiments, a payment processing organization that operates a payment processing network, may receive a premium from a merchant or an issuer to enroll in the chargeback insurance program. In some embodiments, the premiums charged to a merchant or issuer may be decreased if the merchant and/or issuer complies with rules established by the payment processing organization. In some embodiments, the premiums charged to a merchant or issuer may be increased if the merchant and/or issuer fails to comply with rules established by the payment processing organization.

In such embodiments, different merchants or issuers may have different premiums based on, for example, previous chargeback history and enrollment settings (e.g. what chargeback bases the merchant or issuer is enrolled in). For example, if a merchant or issuer has had a number of chargeback requests processed that is greater than a predetermined amount or an average for similar merchants or issuers, the merchant or issuer may be charged a higher premium than a merchant or issuer that has few chargeback requests being processed. In such scenarios, this may be an indication to the payment processing organization that the merchant or issuer is being negligent in how transactions are being processed or fulfilled. In other embodiments, premiums may be based on merchant size (e.g. number or amount of total transactions conducted in a time period, number of employees, number of locations, etc.).

In other embodiments, the enrolled merchant or issuer may be charged a deductible for each chargeback request processed through the chargeback insurance program. The deductible may be based on, for example, previous chargeback history and enrollment settings, and merchant size, as described above. In some embodiments, the deductible may be charged regardless of the basis of the chargeback. In other embodiments, if the chargeback was fraud-based, and the merchant or issuer took all possible steps to mitigate fraud (e.g. security features in merchant or issuer system, merchant or issuer provided all required information), the deductible may be waived or refunded.

### V. Exemplary Computer Apparatuses

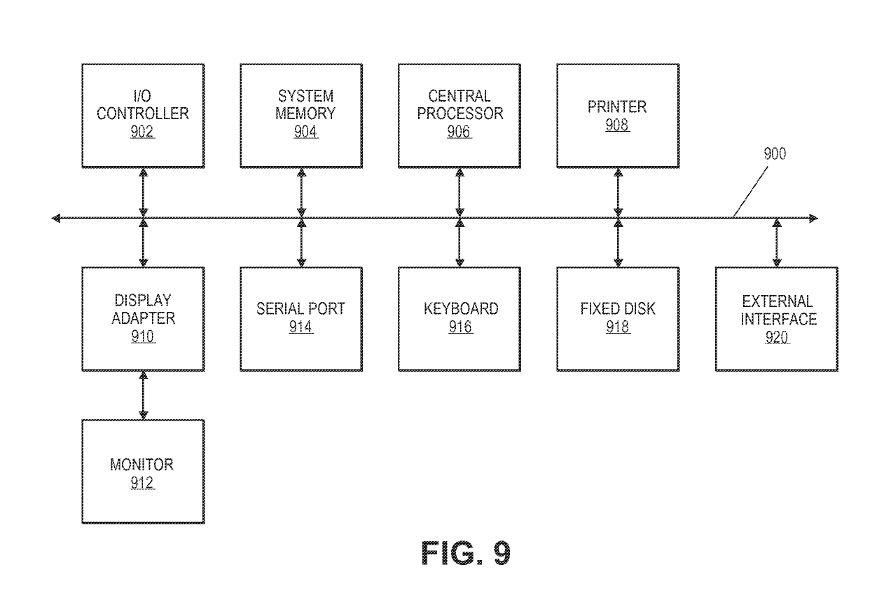

The various participants and elements may operate one or more computer apparatuses (e.g., a server computer) to facilitate the functions described herein. Any of the elements in the figures may use any suitable number of subsystems to facilitate the functions described herein. Examples of such subsystems or components are shown in FIG. 9. The subsystems shown in FIG. 9 are interconnected via a system bus 900. Additional subsystems such as a printer 908, keyboard 916, fixed disk 918 (or other memory comprising computer readable media), monitor 912, which is coupled to display adapter 910, and others are shown. Peripherals and input/output (I/O) devices, which couple to I/O controller 902, can be connected to the computer system by any number of means known in the art, such as serial port 914. For example, serial port 914 or external interface 920 can be used to connect the computer apparatus to a wide area network such as the Internet, a mouse input device, or a scanner. The interconnection via system bus 900 allows the central processor 906 to communicate with each subsystem and to control the execution of instructions from system memory 904 or the fixed disk 918, as well as the exchange of information between subsystems. The system memory 904 and/or the fixed disk 918 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in some embodiments of the present invention. Based on the disclosure and teachings provided herein, a person of ordinary skill in the art will appreciate other ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited in this patent are hereby incorporated by reference for all purposes.

One or more features from any embodiment may be combined with one or more features of any other embodiment without departing from the scope of the disclosure.

In some embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method comprising:
receiving, at a server computer, a chargeback request message from an issuer computer containing a request for a chargeback;
parsing, by the server computer, the chargeback request message;
determining, by the server computer, whether a merchant associated with the chargeback request message is enrolled in a chargeback insurance program;
if the merchant is enrolled in the chargeback insurance program, generating, by the server computer, a chargeback response message indicating approval of the chargeback request message;
transmitting, by the server computer, the chargeback response message to the issuer computer.

2. The method of claim 1, wherein the chargeback request message comprises user account data, chargeback basis data, merchant identification data, and a chargeback amount.

3. The method of claim 1, wherein if the merchant is enrolled in the chargeback insurance program, the merchant does not receive the chargeback request message.

4. The method of claim 1, wherein if the merchant is not enrolled in the chargeback insurance program, the method further comprises:
transmitting the chargeback request message to an acquirer computer associated with the merchant; and
receiving the chargeback response message from the acquirer computer.

5. The method of claim 4, wherein determining whether the merchant associated with the chargeback request message is enrolled in the chargeback insurance program comprises evaluating the merchant identification data contained in the chargeback request message against an enrolled merchants database.

6. The method of claim 1, wherein the chargeback response message further comprises merchant account data.

7. The method of claim 1, further comprising:
receiving, at a server computer, a settlement file for the chargeback from an issuer computer;
evaluating the settlement file to determine the merchant associated with the chargeback; and
sending monetary funds to the issuer computer to settle the chargeback.

8. The method of claim 7, wherein if the merchant is not enrolled in the chargeback insurance program, the settlement file is not sent to an acquirer computer.

9. The method of claim 1, further comprising:
reviewing, by the server computer, a plurality of chargeback request messages associated with the merchant, wherein the plurality of chargeback request messages are stored in a chargeback database; and
determining, by the server computer, whether the plurality of chargeback request messages indicate a pattern of fraudulent chargeback activity.

10. The method of claim 9, wherein a pattern of fraudulent chargeback activity is indicated when the plurality of chargebacks request messages associated with a merchant exceed a predetermined amount.

11. A server computer comprising a processor, and a computer readable medium coupled to the processor, the computer readable medium comprising code for implementing a method comprising:
receiving, at a server computer, a chargeback request message from an issuer computer containing a request for a chargeback;
parsing, by the server computer, the chargeback request message;
determining, by the server computer, whether a merchant associated with the chargeback request message is enrolled in a chargeback insurance program;
if the merchant is enrolled in the chargeback insurance program, generating, by the server computer, a chargeback response message indicating approval of the chargeback request message;
transmitting, by the server computer, the chargeback response message to the issuer computer.

12. The server computer of claim 11, wherein the chargeback request message comprises user account data, chargeback basis data, merchant identification data, and a chargeback amount.

13. The server computer of claim 11, wherein if the merchant is enrolled in the chargeback insurance program, the merchant does not receive the chargeback request message.

14. The server computer of claim 11, wherein if the merchant is not enrolled in the chargeback insurance program, the method further comprises:
transmitting the chargeback request message to an acquirer computer associated with the merchant; and
receiving the chargeback response message from the acquirer computer.

15. The server computer of claim 14, wherein determining whether the merchant associated with the chargeback request message is enrolled in the chargeback insurance program comprises evaluating the merchant identification data contained in the chargeback request message against an enrolled merchants database.

16. The server computer of claim 11, wherein the chargeback response message further comprises merchant account data.

17. The server computer of claim 11, further comprising:
receiving, at a server computer, a settlement file for the chargeback from an issuer computer;
evaluating the settlement file to determine the merchant associated with the chargeback; and
sending monetary funds to the issuer computer to settle the chargeback.

18. The server computer of claim 17, wherein if the merchant is not enrolled in the chargeback insurance program, the settlement file is not sent to an acquirer computer.

19. The server computer of claim 11, further comprising:
reviewing, by the server computer, a plurality of chargeback request messages associated with the merchant, wherein the plurality of chargeback request messages are stored in a chargeback database; and
determining, by the server computer, whether the plurality of chargeback request messages indicate a pattern of fraudulent chargeback activity.

20. The server computer of claim 19, wherein a pattern of fraudulent chargeback activity is indicated when the plurality of chargebacks request messages associated with a merchant exceed a predetermined amount.
